(19) United States
(12) Patent Application Publication
(10) Pub. No.: US 2002/0002529 A1
(43) Pub. Date: Jan. 3, 2002

(54) Electronic intermediating apparatus and method

(76) Inventors: Kazuhiro Tokiwa, Fukuoka (JP); Daisuke Nakamura, Fukuoka (JP)

Correspondence Address: STAAS & HALSEY LLP, 700 11TH STREET, NW, SUITE 500, WASHINGTON, DC, 20001, US

(21) Appl. No.: 09/803,995

(22) Filed: Mar. 13, 2001

(30) Foreign Application Priority Data
Jun. 30, 2000 (JP) 2000-197629

(51) Int. Cl. G06F 17/60

(52) U.S. Cl. 705/37; 705/26

(57) ABSTRACT

A system for intermediating selling and purchasing goods and/or services using a network to which a purchaser terminal that transmits offer information including offer conditions from a purchaser and a seller terminal that transmits sales information including sales conditions from a seller are connected. A sales information registering unit registers the sales conditions and a sales information search unit searches, in the sales information registering unit, the sales conditions matching with the offer conditions and outputs a purchasing result to the purchaser terminal. An offer information registering unit registers the offer conditions when the purchasing result indicates that either the sales conditions match with the offer conditions and a notice from the purchaser indicates non-agreement to the purchasing result, or the sales conditions do not match with the offer conditions. Further, the registering unit registers the offer conditions as a registration information when the purchasing result indicates that the sales conditions match with the offer conditions and a notice from the purchaser indicates agreement to the purchasing result. An offer information search unit receives the sales conditions, searches in the offer information registration unit the offer conditions matching the sales conditions, collects the offer conditions matching the sales conditions, and transmits a sales result to the seller terminal and allows a seller to accept or decline the sales result. A reservation unit registers the search result from the sales information search unit and the offer conditions.

### CROSS-REFERENCE TO RELATED APPLICATIONS

This application is based upon and claims priority of Japanese Patent Application No. 2000-197629 filed Jun. 30, 2000, the contents being incorporated herein by reference.

### BACKGROUND OF THE INVENTION

1. Field of the Invention

The present invention relates to a system and method for intermediating selling and purchasing goods and/or services using a network such as the Internet to which a plurality of terminals are connected.

2. Description of the Related Art

Recently, various electronic information technologies conducting e-business, such as electronic commerce, electronic procurement, and electronic auction or the like, are reported on newspapers. The businesses utilizing online real-time systems (hereinafter referred to as “ORS”) are rapidly growing with infrastructures such as the Internet. Current e-businesses have opened the door to small scale companies and personal companies that are represented as SOHO (i.e., Small Office Home Office), by sublimating the businesses utilizing Information Technology (“IT”) centering on the network which may be realized anytime, anywhere by anyone who desires to utilize ORS.

The first private ORS in the world gave birth to a seat reservation system in the aircraft industry. Presently, the electronic commerce (i.e., online retail market) utilize the Internet as a field for e-business to sell travel goods, such as seat reservations, hotel reservations, rent-a-car reservations, cruising, and travel package reservations. Moreover, many ASPs (i.e., Application Service Providers) are now in competition.

Particularly, various systems for intermediating the purchase of goods or services on the Internet have been established and are widely used. Examples of such Internet intermediating systems follow. In an Internet mail-order type system, sellers collect and present information about particular goods, which then are offered to purchasers. The Internet mail-order type system is the most popular Internet intermediating business. In an auction type system, sellers offer goods and services to intermediating companies and the purchasers tender the bids. In general, the bid price is raised by purchasers but in a method proposed recently, the intermediating company increases the price at a constant price interval. In an inverse auction type system, a purchaser transmits a credit card number to the intermediating company specifying the desired good and associated price.

In response, the seller side presents the charges and the intermediating company makes a bid and executes the settlement. This system is described in U.S. Pat. No. 5,794,207. In a type of system similar to the inverse auction type system, a purchaser bids a price for the desired good to the intermediating company. Thus, the intermediating company only transfers such offer to a particular seller. The transaction is executed only between the particular seller and purchaser. The intermediating company only transfers the information and does not participate in the transaction.

However, the systems discussed above have disadvantages. For instance, in the Internet mail-order type system and in the auction type mediating system, the seller determines the sales price and the purchaser is not permitted to set the price for the goods and/or services to the desired price when presenting the offer for the goods and/or services to the seller.

In contrast, in the inverse auction type system or in the type of system similar to the inverse auction type intermediating system, a purchaser can purchase the goods and services at the desired price. However, in the inverse auction type system, because the settlement is executed when the seller makes a bid, this system is not so convenient for the purchaser because cancellation is not permitted and comparison between other sellers of the goods and services is also not permitted. Moreover, from the seller's viewpoint, the bid for the goods and/or services must be presented for each offer and must be presented as quickly as possible because the offer is also presented to other sellers either in the inverse auction type system or in the type of system similar to the inverse auction type system. Particularly, in the inverse auction type intermediating system, a purchaser is under no obligation to purchase goods or services, thus, the transactional and overhead costs to the sellers is high. The present invention has been proposed considering the problems explained above.

### SUMMARY OF THE INVENTION

An object of the present invention is to provide an intermediating system that can issue a request to a seller from a purchaser and can present the adequate conditions by obtaining the needs of the purchaser from sellers.

In accordance with an exemplary embodiment, the present invention provides for a purchaser terminal that transmits offer conditions from a purchaser. A sales information registering unit registers sales conditions from a seller and a sales information search unit searches in the sales information registering unit the sales conditions matching with the offer conditions from a purchaser and outputting a purchase result to the purchaser. An offer information registering unit registers the offer conditions when the search result indicates that either the sales conditions match with the offer conditions and a notice from the purchaser indicates non-agreement to the search result, or the sales conditions do not match with the offer conditions. Further, the offer information registering unit registers the offer conditions as a purchase when the search result indicates that the sales conditions match with the offer conditions and a notice from the purchaser indicates agreement to the search result. An offer information search unit searches the offer information registering unit for the sales conditions matching the offer conditions and outputting a sales result indicative thereof to the seller.

Goods and/or services mean any kind of goods and/or services that can be obtained from a seller and include tangible and intangible objects. For example, tangible goods may include tickets for receiving accommodation services at a hotel and applications for public transportation. Intangible goods may include downloading contents (e.g., application software, music/video data etc.) as electronic information that is processed with an information processor.

A seller of goods and/or services registers first sales information including sales conditions to an intermediating company via the sales information registering unit in the electronic intermediating apparatus. The sales information may include sales conditions such as sales number, seller's name, location, date, purchase price, and quantity. The registration of this sales information may be executed by transmitting via the seller's terminal registration information to the electronic intermediating apparatus. Registration of the sales information may also be transmitted via manual input operation based on a written request to the intermediating company.

Meanwhile, the purchaser of the goods and/or services transmits from a purchaser terminal the offer information including offer conditions, such as purchase price, and date and time for receiving the services or the like, to the electronic intermediating apparatus. The electronic intermediating apparatus searches the sales information registering unit using the offer conditions included in the offer information as the key, and then transmits the obtained search result to the purchaser.

If a match between the sales conditions and the offer conditions does not exist and/or the purchaser after having received the search result rejects the search result submits a notice canceling the offer, the offer conditions are then registered in the offer information registering unit.

Because the offer conditions rejected are registered in the offer information registering unit, the seller can set new sales conditions by registering the sales information or by correcting the offer conditions of existing sales information, which is then matched with the needs of the purchaser on the basis of the offer conditions. As a result, the chances of selling the goods and/or services increase. In addition, the seller may set the sales information including sales conditions based on the needs issued from a plurality of purchasers and the purchaser is no longer required to make a bid to each offer and transactional and overhead costs decrease. Moreover, a purchaser is not required to make unwanted purchases. The purchaser can purchase under more favorable conditions because changes to the offer is given based on the newly-set sales conditions.

Further, if a match between the sales conditions and the offer conditions does exist, the offer information including the offer conditions are then registered in the offer information registering unit as a purchase. According to this structure, the seller can refer to the offer information registered as a purchase in addition to the offer conditions not registered as a purchase and therefore can set more adequate sales conditions. Thus, the conditions agreed for purchase can be identified, for example, by providing an identifier for each offer information indicating agreement to purchase or the offer information not resulting in a purchase or as a different file to enable a search for both files on the basis of the request from the seller.

In addition, the offer information search unit may sort the offer conditions in the offer information. Specifically, the offer information search unit could collect the various offer conditions by sorting them and sending them to the seller terminal. Thereby, each offer condition in the offer information may be readily accessible allowing the seller to receive adequate offer information.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram illustrating an electronic intermediating apparatus, in accordance with an exemplary embodiment of the present invention.

FIG. 2 is a flowchart illustrating a reservation or offer registration process executed by the electronic intermediating apparatus of FIG. 1 based on an offer from a purchase terminal.

FIGS. 3A-3D are diagrams illustrating a sales table, sales information presented to the purchaser, a reservation table, and an offer table in accordance to the process of FIG. 2.

FIG. 4 is a flowchart illustrating an offer search and response process from a hotel side terminal executed by the electronic intermediating apparatus of FIG. 1.

FIGS. 5A and 5B are diagrams illustrating the information presented to the hotel side terminal and a sales table in accordance to the process of FIG. 4.

### DESCRIPTION OF THE PREFERRED EMBODIMENTS

Reference will now be made in detail to exemplary embodiments of the present invention, of which are illustrated in the accompanying drawings, wherein like reference numerals refer to like elements throughout.

In an exemplary embodiment, the present invention is shown as applied to an accommodation reservation system of a hotel. Specifically, a purchaser is interested in finding hotels for a specific date and in a specific location, offering accommodations for a particular price range. Similarly, several hotels are interested in making available to potential purchasers their sales information with sales conditions.

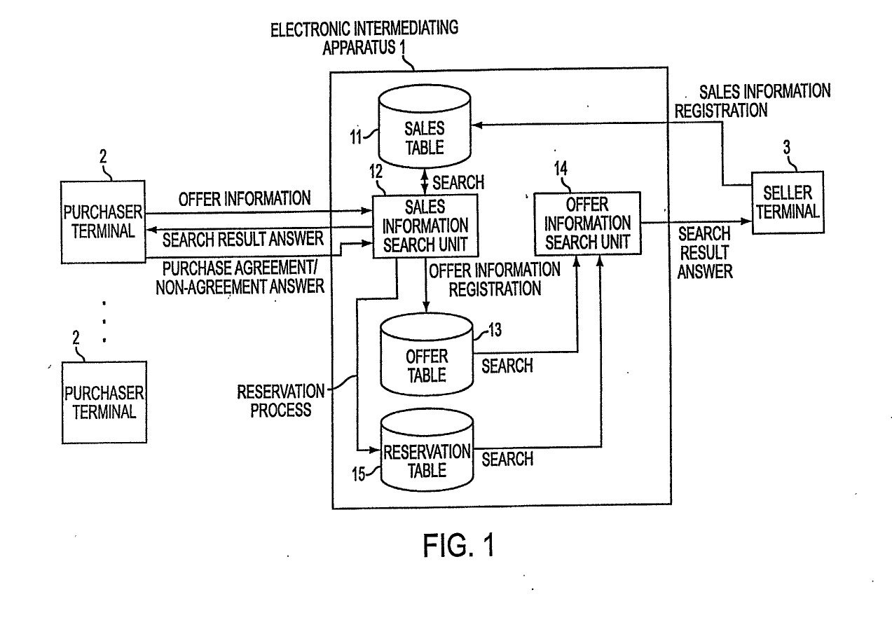

FIG. 1 is a block diagram illustrating an electronic intermediating apparatus 1, in accordance with an exemplary embodiment of the present invention. The electronic intermediating apparatus 1 is a server connected via a two-way communication to one or more purchaser terminals 2 and one or more seller terminals 3 (hereinafter referred to as the hotel side terminal). In an exemplary embodiment, the Internet user is used as the communication infrastructure for the two-way communication. The Internet may be linked between the electronic intermediating apparatus 1 and the purchaser terminal 2 and between the electronic intermediating apparatus 1 and the hotel side terminal 3.

In an exemplary embodiment, the electronic intermediating apparatus 1 is provided with a sales table 11, an offer table 13, and a reservation table 15. In another exemplary embodiment, a logical electronic intermediating apparatus together with a server (not shown) may be implemented to execute a registration process and inspection process by providing each table, for example, as a discrete file connected to a network.

The structural elements of the electronic intermediating apparatus 1 will be explained. The sales table 11 is a sales information registering unit registering sales conditions in sales information provided by the hotel. In an exemplary embodiment, the sales information includes the following sales conditions: sales number, name of hotel, region name, date, purchase price, and quantity. The sales information include the sales conditions and information that is not compared directly with the offer conditions, e.g., sales number, name of hotel, etc. An ordinary person skilled in the art will appreciate that the sales conditions may include other conditions. The sales table 11 may be used to register and correct the sales conditions based on a request issued from the hotel side terminal 3. Registration and correction of sales conditions are performed after authentication of the hotel side terminal 3. A sales information search unit 12 searches the sales table 11 based on an offer information including offer conditions transmitted from the purchaser terminal 2 and sends a search result, as an offer result, to the purchaser terminal 2. For illustrative purposes, the offer information includes the following conditions: offer number, region name, date, sales price, and quantity. Other offer conditions may be included such as name of purchaser.

An offer table 13 is an offer information registering unit registering the offer conditions in the offer information when the sales conditions match with the offer conditions. Further, the offer table 13 registers the offer information when a notice from the purchaser terminal 2 indicates non-agreement to the search result, i.e., the purchaser decides to cancel or withdraw the offer although there is a match between the sales information and the conditions in the sales table 11. The offer information include the offer conditions and information that is not compared directly with the sales conditions, e.g., offer number, purchase number, etc.

An offer information search unit 14 searches the offer table 13 for the offer conditions matching with the sales conditions based on a search request from the hotel side terminal 3 and outputs a search result, as a sales result, to the hotel side terminal 3 regarding the request. Here, the offer information search unit 14 may also be provided with a function to search the reservation table 15. The reservation table 15 registers the search result from the sales information search unit 12 and the offer conditions from the purchaser terminal 2.

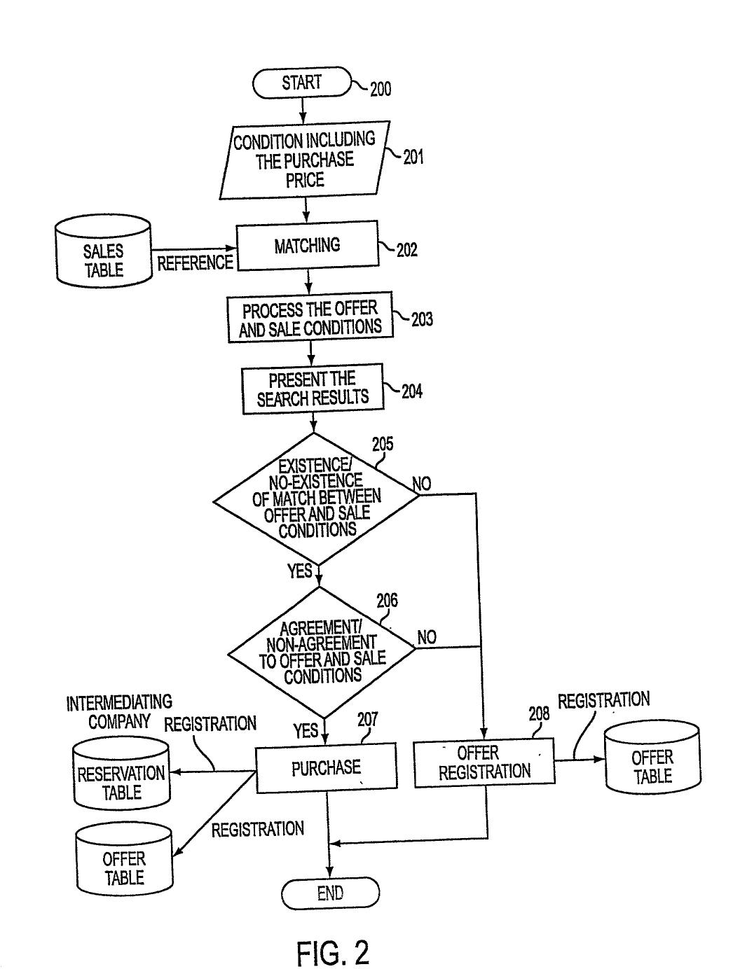

FIG. 2 is a flowchart illustrating a reservation or offer registration process executed by the electronic intermediating apparatus 1 based on an offer from a purchaser terminal 2. At operation 200, memories are cleared, initial flag conditions are set, etc., as is well known in the art. At operation 201, the offer information including offer conditions is received from the purchaser terminal 2. The offer conditions include three types of conditions of purchase: price information, regional condition, and staying schedule. For purposes of brevity, the offer information and sales information explained herein include only three types of conditions, however, other types of conditions may be included. At operation 202, the sales information search unit 12 searches the sales table 11 based on the offer conditions received from the purchaser terminal 2 and determines the sales conditions that match with the offer conditions. The sales information search unit 12 then outputs a search result to the purchasing terminal 2.

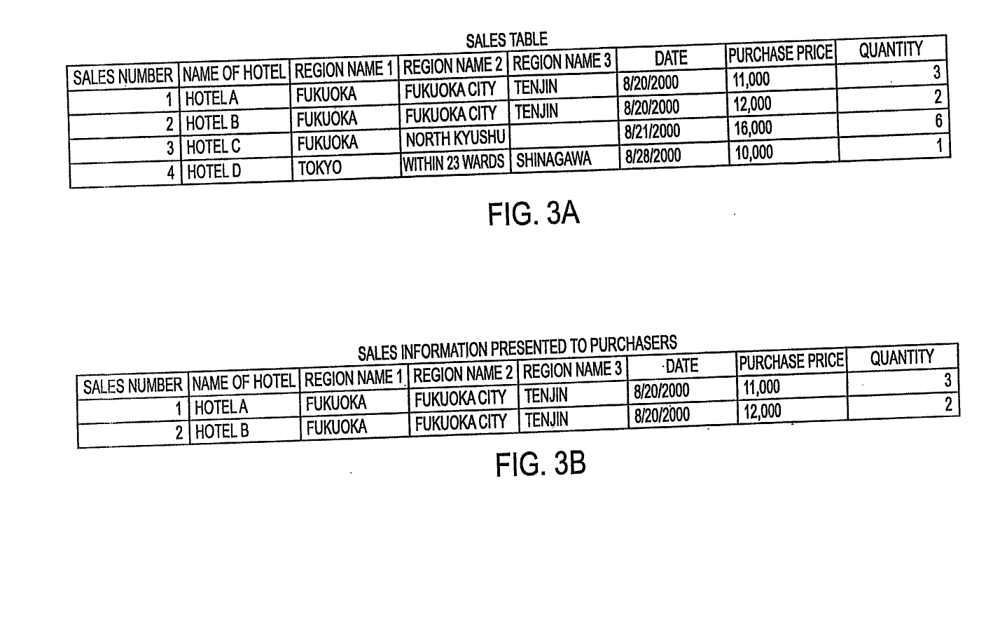

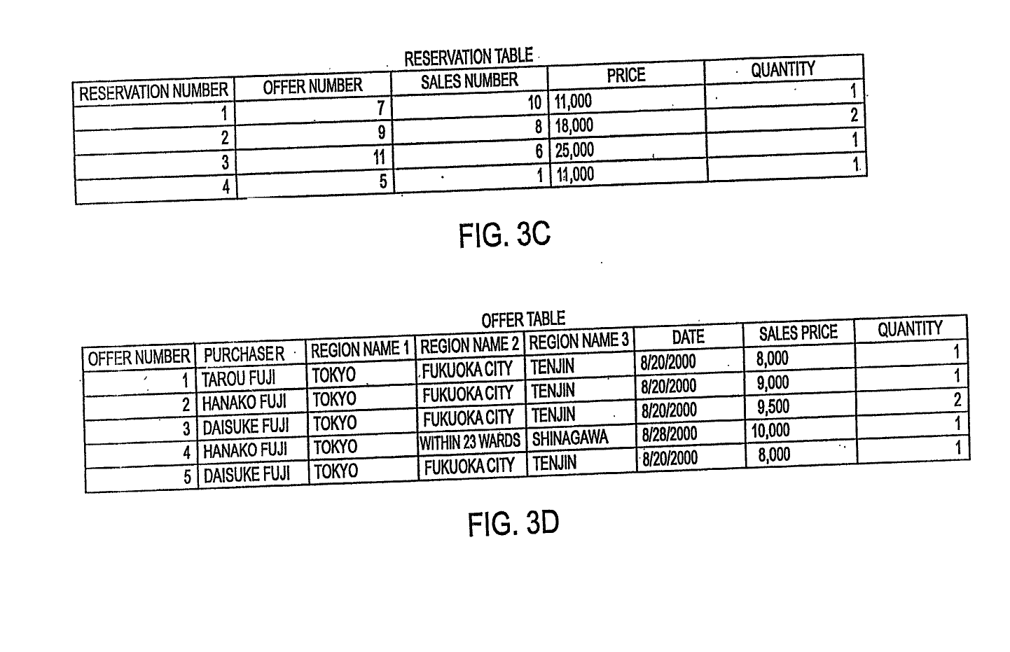

The sales conditions registered in the sales table 11 is illustrated in FIG. 3A. In the sales table 11, sales number (i.e., a serial number given to each sales information), name of hotel, regional condition of hotel (i.e., a name of regions 1 to 3), date, sales price, and amount of sales (remaining number of rooms for accommodation under this condition) are registered. For example, the offer conditions received from the purchaser terminal 2 includes the following: Region: Tenjin, Fukuoka-City, Fukuoka-Pre.; Date: Aug. 20, 2000; Overnight stay; and Purchase price: ¥12,000 or less.

At operation 203, the sales information unit 12 processes the search result of the two sales information and the offer information for display offer information. At operation 204, the sales information unit 12 transmits the processed search result to the purchaser terminal 2 that has transmitted the offer information.

Thus, in FIG. 3A, because the sales numbers 1 and 2 conform to the above conditions, the sales information of the sales number 1 and 2 are transmitted to the purchaser terminal 2. Thus, the sales information including the sales conditions to be transmitted to the purchaser is illustrated in FIG. 3B.

Referring to FIG. 2, at operation 205, a determination is made of the existence or nonexistence of a match between the sales conditions and the offer conditions. If there is a match, the process proceeds to operation 206. At operation 206, a determination is made of an agreement or non-agreement to the search result indicating the sales conditions matching the offer conditions. Specifically, once a match between the sales information and the offer information is determined, a notice indicative of the match is transmitted to the purchaser via the purchaser terminal 2. The purchaser then confirms the purchase by accepting or declining the search result. If the purchaser agrees to proceed with the purchase in view of the sales conditions matching the offer conditions, then the process proceeds to operation 207. At operation 207, the purchaser transmits a notice via the purchaser terminal indicative of the purchase and a choice of hotel also shown in the search result. The offer conditions are then registered in the offer table 13. An example of registering the sales information in the reservation table 15 is illustrated in FIG. 3C. To this reservation table, the reservation number (serial number of reservation information), sales number (corresponding to the sales number in the sales table 10), price, and amount of reservations are registered.

However, if at operation 205, a determination is made of the non-existence of a match between the sales conditions and the offer conditions, then the process proceeds to operation 208. Further, if at operation 206, the purchaser does not agree to proceed and desires the cancel or withdraw from the offer, then the process proceeds to operation 208. At operation 208, the offer conditions are registered in the offer table 13. An example of the offer conditions registered in the offer table 13 is illustrated in FIG. 3D. The offer conditions registered includes the offer number (i.e., a serial number), name of purchaser, name of regions 1 to 3 for staying overnight, date, desired purchase price, and desired number of rooms.

However, if the desired purchase price is ¥8,000 or less in the example above, the sales conditions in the sales table illustrated in FIG. 3A do not satisfy the offer conditions or the sales conditions do not match the offer conditions. Therefore, as illustrated in FIG. 3D, the offer conditions are recorded as offer number 5 in addition to the existing offer numbers 1 to 4.

However, the purchase process is not always required to follow the process as explained above. For example, the offer information can also be transferred directly to the hotel that received the reservation (for this purpose, the reservation table is not the essential factor in the present invention) and it is not necessary to register the sales information in the offer table 13.

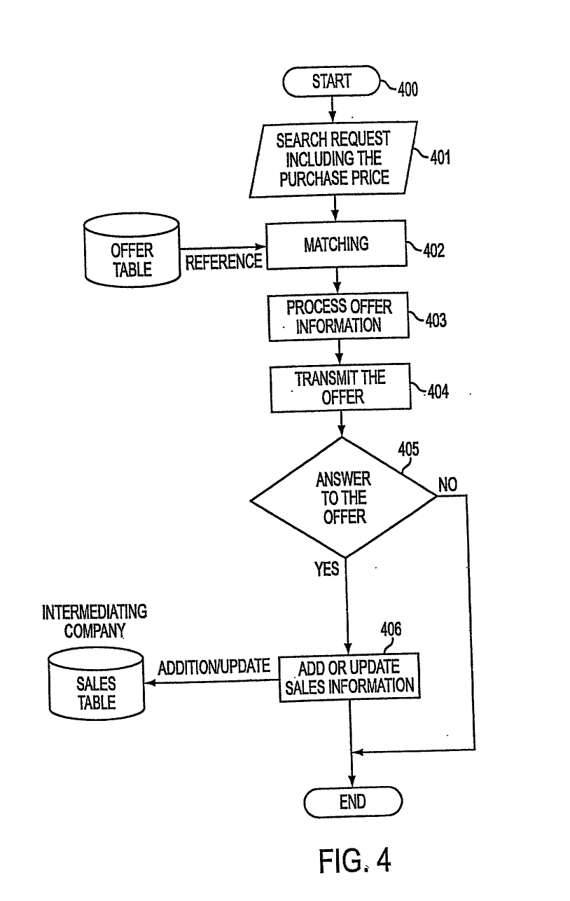

Search of an offer and response process executed by the electronic intermediating apparatus 1 will be explained with reference to the flowchart of FIG. 4. Specifically, FIG. 4 illustrates the scenario when the hotel desires to present sales conditions and search for offer conditions matching the sales conditions. At operation 400, memories are cleared, initial flag conditions are set, etc., as is well known in the art. At operation 401, the hotel side terminal 3 transmits a search request including purchase price to the offer information search unit 14.

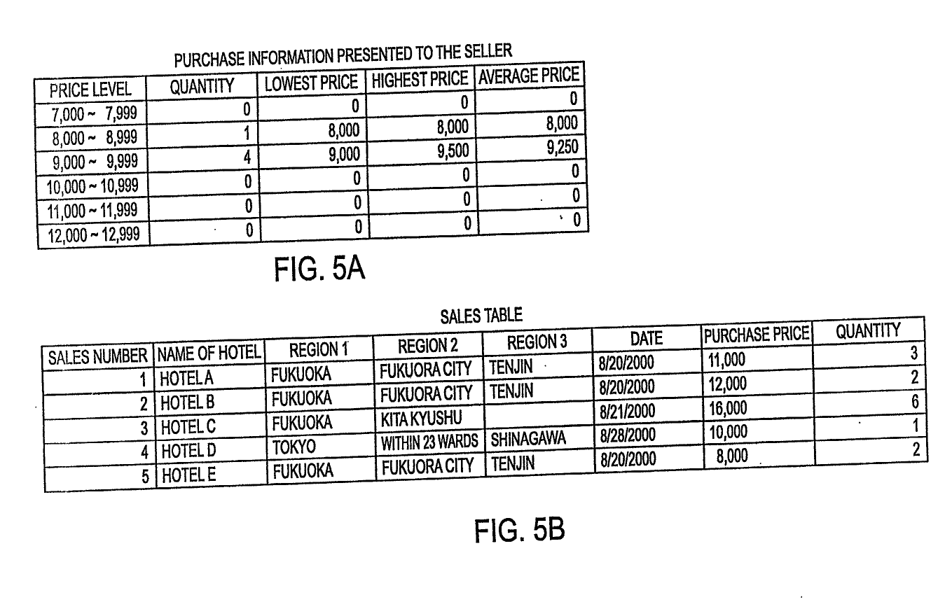

For illustrative purposes, the offer table 30 contains information as shown in FIG. 3D. The search request from the hotel includes the following information: Region: Tenjin, Fukuoka-City, Fukuoka-Pre.; Date: Aug. 20, 2000; Desired purchase price: ¥6,000 to ¥12,000. At operation 402, the offer information search unit 14 searches in the offer table 13 the offer information including the offer conditions satisfying the search request and collects the offer information matching the sales conditions. At operation 403, the offer information including offer conditions matching the sales conditions is processed for display purposes. At operation 404, the offer information collected and processed is then transmitted to the hotel side terminal 3. An example of the transmitted offer to purchase information is illustrated in FIG. 5A. In FIGS. 5A and 5B, the offer information satisfying the search condition is collected for each price level and subsequently presented to the seller, i.e., the hotel side terminal 2. Moreover, highest price, lowest price, and average price in the price level are also presented to the seller.

At operation 405, a determination is made whether to accept or decline the sale although the sales information matched the offer information. If the offer to purchase information is accepted, the process proceeds to operation 406. At operation 406, the sales information is registered in the sales table 11 as either new or updated sales information based on the offer information. If the offer to purchase information is not accepted, the process ends.

A preferred embodiment of the present invention has been explained above, considering an example of the hotel reservation system, but the present invention is not limited thereto and allows various applications to various goods/service networks.

As explained above, the electronic intermediating apparatus and method of the present invention enables a seller to refer to the offer information including the offer conditions from a plurality of purchasers. The purchase is realized by setting the sales conditions to match with the needs of purchasers, thereby increasing sales and decreasing the number of unsold goods or services. Moreover, it is no longer required to make a bid by setting the sales condition for each offer and thereby the transactional and overhead costs reduced. Moreover, from the point of view of the purchaser, the purchase is executed in a desirable condition because the purchase contract is never agreed under a non-desirable offer condition.

Although preferred embodiments of the present invention have been shown and described, it will be appreciated by those skilled in the art that changes may be made in these embodiments without departing from the principle and sprit of the invention, the scope of which is defined in the appended claims and their equivalents.

What is claimed is:

1. An apparatus, comprising:
a purchaser terminal transmitting offer conditions from a purchaser;
a sales information registering unit registering sales conditions;
a sales information search unit determining the sales conditions matching with the offer conditions and outputting a search result indicative thereof to the purchasing terminal; and
an offer information registering unit registering the offer conditions when the search result indicates that either the sales conditions match with the offer conditions and a notice from the purchaser indicates non-agreement to the search result, or the sales conditions do not match with the offer conditions.

2. The apparatus as recited in claim 1, wherein the offer information registering unit, upon receipt of the notice indicating agreement to the search result, provides identification of each offer condition.

3. The apparatus as recited in claim 1, wherein the offer information search unit sorts the offer conditions, collects the number of offer conditions, and transmits the offer conditions sorted and the number of offer conditions to the seller terminal.

4. An apparatus, comprising:
a purchaser terminal transmitting offer conditions from a purchaser;
a sales information registering unit registering sales conditions from a seller;
a sales information search unit searching in the sales information registering unit the sales conditions matching with the offer conditions from a purchaser and outputting a purchase result to the purchaser;
an offer information registering unit registering the offer conditions when the search result indicates that either the sales conditions match with the offer conditions and a notice from the purchaser indicates non-agreement to the search result, or the sales conditions do not match with the offer conditions, and registering the offer conditions as a purchase when the search result indicates that the sales conditions match with the offer conditions and a notice from the purchaser indicates agreement to the search result; and
an offer information search unit searching the offer information registering unit for the sales conditions matching the offer conditions and outputting a sales result indicative thereof to the seller.

5. The apparatus as recited in claim 4, wherein the offer information registering unit, upon receipt of the notice indicating agreement to the search result, provides identification of each offer condition.

6. The apparatus as recited in claim 4, wherein the offer information search unit sorts the offer conditions, collects the number of offer conditions, and transmits the offer conditions sorted and the number of offer conditions to the seller terminal.

7. An apparatus, comprising:
a seller terminal transmitting sales information comprising sales conditions from a seller;
an offer information registration unit registering offer information comprising offer conditions; and
an offer information search unit receiving the sales conditions, searching in the offer information registration unit the offer conditions matching the sales conditions, collecting the offer conditions matching the sales conditions, and transmitting a sales result to the seller terminal comprising the offer conditions matching the sales conditions and allowing the seller to accept or decline the sales result.

8. The apparatus as recited in claim 7, further comprising a sales information registering unit registering the sales conditions when the seller accepts the sale.

9. The apparatus as recited in claim 7, further comprising a sales information registering unit updating the sales conditions when the seller accepts the sale.

10. An apparatus, comprising:
a purchaser terminal transmitting offer information comprising offer conditions from a purchaser;
a seller terminal transmitting sales information comprising sales conditions from a seller;
a sales information registering unit registering the sales conditions;
a sales information search unit searching, in the sales information registering unit, the sales conditions matching with the offer conditions and outputting a purchasing result to the purchaser terminal;
an offer information registering unit registering the offer conditions when the purchasing result indicates that either the sales conditions match with the offer conditions and a notice from the purchaser indicates non-agreement to the purchasing result, or the sales conditions do not match with the offer conditions, and registering the offer conditions as a registration information when the purchasing result indicates that the sales conditions match with the offer conditions and a notice from the purchaser indicates agreement to the purchasing result;
an offer information search unit receiving the sales conditions, searching in the offer information registration unit the offer conditions matching the sales conditions, collecting the offer conditions matching the sales conditions, and transmitting a sales result to the seller terminal comprising the offer conditions matching the sales conditions and allowing a seller to accept or decline the sales result; and
a reservation unit registering the search result from the sales information search unit and the offer conditions.

11. An apparatus, comprising:
purchaser means for transmitting offer conditions from a purchaser;
sales information registering means for registering sales conditions;
sales information search means for determining the sales conditions matching with the offer conditions and outputting a search result indicative thereof to the purchasing means; and
offer information registering means for registering the offer conditions when the search result indicates that either the sales conditions match with the offer conditions and a notice from the purchaser indicates non-agreement to the search result, or the sales conditions do not match with the offer conditions.

12. An apparatus, comprising:
purchaser means for transmitting offer conditions from a purchaser;
sales information registering means for registering sales conditions from a seller;
sales information search means for searching in the sales information registering means the sales conditions matching with the offer conditions and outputting a purchase result to the purchaser;
offer information registering means for registering the offer conditions when the search result indicates that either the sales conditions match with the offer conditions and a notice from the purchaser indicates non-agreement to the search result, or the sales conditions do not match with the offer conditions, and registering the offer conditions as a purchase when the search result indicates that the sales conditions match with the offer conditions and a notice from the purchaser indicates agreement to the search result; and
offer information search means for searching the offer information registering means for the sales conditions matching the offer conditions from the seller and outputting a sales result indicative thereof to the seller.

13. An apparatus, comprising:
seller means for transmitting sales information comprising sales conditions from a seller;
offer information registration means for registering offer information comprising offer conditions; and
offer information search means for receiving the sales conditions, searching in the offer information registration means the offer conditions matching the sales conditions, collecting the offer conditions matching the sales conditions, and transmitting a sales result to the seller means comprising the offer conditions matching the sales conditions and allowing the seller to accept or decline the sales result.

14. An apparatus, comprising:
purchaser means for transmitting offer information comprising offer conditions;
seller means for transmitting sales information comprising sales conditions;
sales information registering means for registering the sales conditions;
sales information search means for searching, in the sales information registering means, the sales conditions matching with the offer conditions and outputting a purchasing result to the purchaser means;
offer information registering means for registering the offer conditions when the purchasing result indicates that either the sales conditions match with the offer conditions and a notice from a purchaser indicating non-agreement to the purchasing result, or the sales conditions do not match with the offer conditions, and for registering the offer conditions as a registration information when the purchasing result indicates that the sales conditions match with the offer conditions and a notice from the purchaser indicates agreement to the purchasing result;
offer information search means for receiving the sales conditions, searching in the offer information registration means the offer conditions matching the sales conditions, collecting the offer conditions matching the sales conditions, and transmitting a sales result to the seller means comprising the offer conditions matching the sales conditions and allowing a seller to accept or decline the sales result; and
reservation means for registering the search result from the sales information search means and the offer conditions.

15. A method, comprising:
transmitting offer conditions from a purchaser;
registering sales conditions;
determining the sales conditions matching with the offer conditions and outputting a search result indicative thereof;
registering the offer conditions when the search result indicates that either the sales conditions match with the offer conditions and a notice from the purchaser indicates non-agreement to the search result, or the sales conditions do not match with the offer conditions; and
registering the offer conditions as a purchase when the search result indicates that the sales conditions match with the offer conditions and a notice from the purchaser indicates agreement to the search result.

16. The method as recited in claim 15, further providing identification of each offer condition upon receipt of the notice indicating agreement to the search result.

17. The method as recited in claim 15, further comprising
sorting the offer conditions;
collecting the number of offer conditions; and
transmitting the offer conditions sorted and the number of offer conditions.

18. A method, comprising:
transmitting offer conditions from a purchaser;
searching for sales conditions from a seller matching with the offer conditions and outputting a purchase result;
registering the offer conditions when the search result indicates that either the sales conditions match with the offer conditions and a notice from the purchaser indicates non-agreement to the search result, or the sales conditions do not match with the offer conditions;
registering the offer conditions as a purchase when the search result indicates that the sales conditions match with the offer conditions and a notice from the purchaser indicates agreement to the search result; and
searching for the sales conditions matching the offer conditions from the seller and outputting a sales result indicative thereof to the seller.

19. The method as recited in claim 18, further providing identification of each offer condition upon receipt of the notice indicating agreement to the search result.

20. The method as recited in claim 18, further comprising
sorting the offer conditions;
collecting the number of offer conditions; and
transmitting the offer conditions sorted and the number of offer conditions.

21. A method, comprising:
transmitting sales information comprising sales conditions from a seller;
registering offer information comprising offer conditions from a purchaser;
receiving the sales conditions;
searching the offer conditions matching the sales conditions;
collecting the offer conditions matching the sales conditions; and
transmitting a sales result to a seller terminal comprising the offer conditions matching the sales conditions and allowing the seller to accept or decline the sales result.

22. The method as recited in claim 21, further comprising registering the sales conditions when the seller accepts the sale.

23. The method as recited in claim 21, further comprising updating the sales conditions when the seller accepts the sale.

24. A method, comprising:
transmitting offer information comprising offer conditions via a purchaser terminal;
transmitting sales information comprising sales conditions via a seller terminal;
registering sales conditions;
searching the sales conditions matching with the offer conditions and outputting a purchasing result to the purchaser terminal;
registering the offer conditions when the purchasing result indicates that either the sales conditions match with the offer conditions and a notice from the purchaser terminal indicates non-agreement to the purchasing result, or the sales conditions do not match with the offer conditions;
registering the offer conditions as a registration information when the purchasing result indicates that the sales conditions match with the offer conditions and a notice from the purchaser terminal indicates agreement to the purchasing result;
receiving the sales conditions;
searching the offer conditions matching the sales conditions;
collecting the offer conditions matching the sales conditions;
transmitting a sales result comprising the offer conditions matching the sales conditions and allowing a seller to accept or decline the sales result; and
registering the search result from the sales information search means and the offer conditions.

25. A computer readable storage medium controlling a computer and comprising a process of:
transmitting offer conditions from a purchaser;
registering sales conditions;
determining the sales conditions matching with the offer conditions and outputting a search result indicative thereof;
registering the offer conditions when the search result indicates that either the sales conditions match with the offer conditions and a notice from the purchaser indicates non-agreement to the search result, or the sales conditions do not match with the offer conditions; and
registering the offer conditions as a purchase when the search result indicates that the sales conditions match with the offer conditions and a notice from the purchaser indicates agreement to the search result.

26. The computer readable storage medium as recited in claim 25, further providing identification of each offer condition upon receipt of the notice indicating agreement to the search result.

27. The computer readable storage medium as recited in claim 25, further comprising
sorting the offer conditions;
collecting the number of offer conditions; and
transmitting the offer conditions sorted and the number of offer conditions.

28. A computer readable storage medium controlling a computer and comprising a process of:
transmitting offer conditions from a purchaser;
searching for sales conditions from a seller matching with the offer conditions and outputting a purchase result;
registering the offer conditions when the search result indicates that either the sales conditions match with the offer conditions and a notice from the purchaser indicates non-agreement to the search result, or the sales conditions do not match with the offer conditions;
registering the offer conditions as a purchase when the search result indicates that the sales conditions match with the offer conditions and a notice from the purchaser indicates agreement to the search result; and
searching for the sales conditions matching the offer conditions from the seller and outputting a sales result indicative thereof to the seller.

29. The computer readable storage medium as recited in claim 28, further providing identification of each offer condition upon receipt of the notice indicating agreement to the search result.

30. The computer readable storage medium as recited in claim 28, further comprising
sorting the offer conditions;
collecting the number of offer conditions; and
transmitting the offer conditions sorted and the number of offer conditions.

31. A computer readable storage medium controlling a computer and comprising a process of:
transmitting sales information comprising sales conditions from a seller;
registering offer information comprising offer conditions from a purchaser;
receiving the sales conditions;
searching the offer conditions matching the sales conditions;
collecting the offer conditions matching the sales conditions; and
transmitting a sales result to a seller terminal comprising the offer conditions matching the sales conditions and allowing the seller to accept or decline the sales result.

32. The computer readable storage medium as recited in claim 31, further comprising registering the sales conditions when the seller accepts the sale.

33. The computer readable storage medium as recited in claim 31, further comprising updating the sales conditions when the seller accepts the sale.

34. A computer readable storage medium controlling a computer and comprising a process of:
transmitting offer information comprising offer conditions via a purchaser terminal;
transmitting sales information comprising sales conditions via a seller terminal;
registering sales conditions;
searching the sales conditions matching with the offer conditions and outputting a purchasing result to the purchaser terminal;
registering the offer conditions when the purchasing result indicates that either the sales conditions match with the offer conditions and a notice from the purchaser terminal indicates non-agreement to the purchasing result, or the sales conditions do not match with the offer conditions;
registering the offer conditions as a registration information when the purchasing result indicates that the sales conditions match with the offer conditions and a notice from the purchaser terminal indicates agreement to the purchasing result;
receiving the sales conditions;
searching the offer conditions matching the sales conditions;
collecting the offer conditions matching the sales conditions;
transmitting a sales result comprising the offer conditions matching the sales conditions and allowing a seller to accept or decline the sales result; and
registering the search result from the sales information search means and the offer conditions.
